(19) United States
(12) Patent Application Publication
(10) Pub. No.: US 2024/0168416 A1
(43) Pub. Date: May 23, 2024

(54) ROTATION DEVICE, FIXING DEVICE, AND IMAGE FORMING APPARATUS

(71) Applicant: FUJIFILM Business Innovation Corp., Tokyo (JP)

(72) Inventors: Hideki KUGE, Kanagawa (JP); Yoshiki Shimodaira, Kanagawa (JP); Masato Yamashita, Kanagawa (JP); Takayuki Ukawa, Kanagawa (JP); Yutaka Kiuchi, Kanagawa (JP)

(73) Assignee: FUJIFILM Business Innovation Corp., Tokyo (JP)

(21) Appl. No.: 18/320,583

(22) Filed: May 19, 2023

(30) Foreign Application Priority Data
Nov. 22, 2022 (JP) 2022-186484

(51) Int. Cl. G03G 15/20

(52) U.S. Cl. CPC G03G 15/2025; G03G 2221/0089

(57) ABSTRACT

A rotation device includes a rotator that includes a recessed portion formed on an outer circumferential surface and that rotates in a predetermined rotation direction, a removing unit that comes into contact with a portion of the outer circumferential surface in a range from an upstream end to a downstream end of the recessed portion in the rotation direction due to rotation of the rotator and that removes a foreign substance that adheres to the outer circumferential surface, an application unit that applies an inward load to the removing unit inward in a radial direction of the rotator, and an inclined surface that is located at the removing unit or the upstream end and that comes into contact with the other of the removing unit or the upstream end to move the removing unit entering the recessed portion due to the inward load outward in the radial direction of the rotator along with rotation of the rotator.

### CROSS-REFERENCE TO RELATED APPLICATIONS

This application is based on and claims priority under 35 USC 119 from Japanese Patent Application No. 2022-186484 filed Nov. 22, 2022.

### BACKGROUND

### (i) Technical Field

The present disclosure relates to a rotation device, a fixing device, and an image forming apparatus.

### (ii) Related Art

Japanese Unexamined Patent Application Publication No. 2011-184189 discloses a medium transport apparatus including an impression cylinder and a contact member, the impression cylinder is cylindrical, rotates about a central axis to transport a medium that is supported on a circumferential surface, includes a fixation member that fixes an edge portion of the medium in a transport direction over the entire width of the medium that is supported on the circumferential surface in a direction substantially perpendicular to the transport direction, and includes cam portions that are disposed outside both ends of the fixation member in the direction substantially perpendicular to the transport direction and that protrude from the circumferential surface to positions higher than that of the fixation member, the contact member has a length greater than a distance between the cam portions in the direction substantially perpendicular to the transport direction, is urged so as to come into contact with the medium that is supported on the circumferential surface of the impression cylinder, and rides on the cam portions so as not to come into contact with the fixation member, the impression cylinder includes a first magnetic field generator that generates a predetermined magnetic field at least at positions on the circumferential surface at which the contact member rises on the cam portions, and the contact member includes a second magnetic field generator that generates a magnetic field for producing repulsive force against the magnetic field that is generated by the first magnetic field generator.

Japanese Unexamined Patent Application Publication No. 2017-32841 discloses an image heating apparatus including a first rotator that heats a toner image on a recording material at a nip portion, a pair of second rotators that forms the nip portion in cooperation with the first rotator, that comes into contact with a surface of the recording material opposite a surface on which the toner image is carried, and that includes fluorine resin layers on the surfaces, a collection member that performs a collection process of collecting fluorine resin powder from the second rotators by coming into contact with the surfaces of the second rotators, a first contact-separation mechanism that causes the collection member to come into contact with or to be separated from the surfaces of the second rotators, a sliding rotator that comes into contact with the second rotators at a different circumference speed and consequently performs a sliding process of sliding on the surfaces of the second rotators, a second contact-separation mechanism that causes the sliding rotator to come into contact with or to be separated from the surfaces of the second rotators, and a performing unit that controls the first contact-separation mechanism and the second contact-separation mechanism such that the sliding process and the collection process are simultaneously performed. The nip portion, the sliding rotator, and the collection member are arranged in this order in a direction in which the second rotators rotate.

### SUMMARY

It is thought that a rotation device includes a rotator that includes a recessed portion formed on an outer circumferential surface and that rotates in a predetermined rotation direction, a removing unit that comes into contact with a portion of the outer circumferential surface in a range from an upstream end to a downstream end of the recessed portion in the rotation direction due to rotation of the rotator and that removes a foreign substance that adheres to the outer circumferential surface, and an application unit that applies an inward load to the removing unit inward in a radial direction of the rotator.

As for the rotation device, the removing unit enters the recessed portion due to the inward load that is applied inward in the radial direction of the rotator. If the removing unit that enters the recessed portion remains in the recessed portion, the removing unit collides with, for example, a side surface of the recessed portion and is damaged in some cases.

Aspects of non-limiting embodiments of the present disclosure relate to reduction of damage to a removing unit, unlike the case where a removing unit that enters a recessed portion remains in the recessed portion.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a rotation device including a rotator that includes a recessed portion formed on an outer circumferential surface and that rotates in a predetermined rotation direction; a removing unit that comes into contact with a portion of the outer circumferential surface in a range from an upstream end to a downstream end of the recessed portion in the rotation direction due to rotation of the rotator and that removes a foreign substance that adheres to the outer circumferential surface; an application unit that applies an inward load to the removing unit inward in a radial direction of the rotator; and an inclined surface that is located at the removing unit or the upstream end and that comes into contact with the other of the removing unit or the upstream end to move the removing unit entering the recessed portion due to the inward load outward in the radial direction of the rotator along with rotation of the rotator.

### BRIEF DESCRIPTION OF THE DRAWINGS

An exemplary embodiment of the present disclosure will be described in detail based on the following figures, wherein:

FIG. 1 schematically illustrates an image forming apparatus according to the present exemplary embodiment;

FIG. 2 is a perspective view of the structure of the vicinity of a transfer cylinder according to the present exemplary embodiment;

FIG. 3 is a perspective view of the structure of the vicinity of a fixing cylinder according to the present exemplary embodiment;

FIG. 4 is a perspective view of grippers according to the present exemplary embodiment;

FIG. 5 schematically illustrates a cleaning mechanism and the fixing cylinder according to the present exemplary embodiment;

FIG. 6 schematically illustrates the cleaning mechanism according to the present exemplary embodiment;

FIG. 7 schematically illustrates an enlarged view of a portion of the cleaning mechanism according to the present exemplary embodiment;

FIG. 8 schematically illustrates a modification to an inclined surface; and

FIG. 9 schematically illustrates a modification to a compression spring.

### DETAILED DESCRIPTION

An exemplary embodiment of the present disclosure will hereinafter be described by way of example with reference to the figures.

### Image Forming Apparatus 10

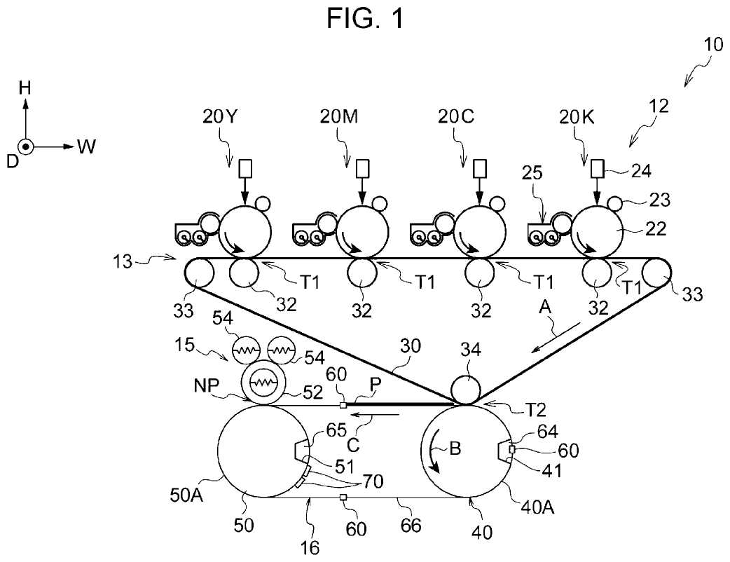

The structure of an image forming apparatus 10 according to the present exemplary embodiment will be described. FIG. 1 schematically illustrates the structure of the image forming apparatus 10 according to the present exemplary embodiment. In the figures, an arrow H represents the vertical direction and an up-down direction of the apparatus, an arrow W represents the horizontal direction and a width direction of the apparatus, and an arrow D represents the horizontal direction and a depth direction of the apparatus (a front-rear direction of the apparatus). Ratios of the dimensions of components illustrated in the figures in the H direction, the W direction, and the D direction differ from actual ratios of the dimensions in some cases.

The image forming apparatus 10 illustrated in FIG. 1 forms toner images (examples of an image) on a recording medium P. Specifically, the image forming apparatus 10 includes an image forming unit 12, a fixing device 15, and a transport mechanism 16. The components (the image forming unit 12, the fixing device 15, and the transport mechanism 16) of the image forming apparatus 10 will now be described.

### Image Forming Unit 12

The image forming unit 12 forms the toner images on the recording medium P by using an electrophotographic system. Specifically, as illustrated in FIG. 1, the image forming unit 12 includes toner image forming units 20 that form the toner images and a transfer device 13 that transfers the toner images that are formed by the toner image forming units 20 to the recording medium P.

### Toner Image Forming Units 20

The multiple toner image forming units 20 illustrated in FIG. 1 form the toner images in colors. According to the present exemplary embodiment, the toner image forming units 20 for four colors of yellow (Y), magenta (M), cyan (C), and black (K) in total are provided. Symbols of (Y), (M), (C), and (K) illustrated in FIG. 1 represent components for the respective colors described above.

The toner image forming units 20 for the respective colors have the same structure except for toner to be used. Accordingly, the components of the toner image forming unit 20(K) as a representative of the toner image forming units 20 for the respective colors are designated by reference characters in FIG. 1.

Specifically, the toner image forming units 20 for the respective colors include photoconductor members 22 that rotate in a direction (for example, a counterclockwise direction in FIG. 1). The toner image forming units 20 for the respective colors also include chargers 23, exposure devices 24, and developing devices 25.

As for the toner image forming units 20 for the respective colors, the chargers 23 charge the photoconductor members 22. The exposure devices 24 expose the photoconductor members 22 that are charged by the chargers 23 to light and form electrostatic latent images on the photoconductor members 22. The developing devices 25 develop the electrostatic latent images that are formed on the photoconductor members 22 by using the exposure devices 24 and form the toner images.

### Transfer Device 13

The transfer device 13 illustrated in FIG. 1 transfers the toner images that are formed by the toner image forming units 20 to the recording medium P. Specifically, the transfer device 13 performs first transfer by which the toner images on the photoconductor members 22 for the respective colors are stacked on a transfer belt 30 that serves as an intermediate transfer body and second transfer by which the stacked toner images are transferred to the recording medium P. As illustrated in FIG. 1, the transfer device 13 includes the transfer belt 30, first transfer rollers 32, and a transfer cylinder 40.

The first transfer rollers 32 transfer the toner images on the photoconductor members 22 for the respective colors to the transfer belt 30 at first transfer positions T1 between the photoconductor members 22 and the first transfer rollers 32. According to the present exemplary embodiment, a first transfer electric field is applied between the first transfer rollers 32 and the photoconductor members 22, and the toner images that are formed on the photoconductor members 22 are consequently transferred to the transfer belt 30 at the first transfer positions T1.

The toner images on the photoconductor members 22 for the respective colors are transferred to an outer circumferential surface of the transfer belt 30. As illustrated in FIG. 1, the transfer belt 30 has no ends and is wound around multiple rollers 33 and a facing roller 34 so as to have an inverted triangle shape in a front view (when viewed in the depth direction of the apparatus). At least one of the multiple rollers 33 is rotated, and the transfer belt 30 consequently turns in the direction of an arrow A.

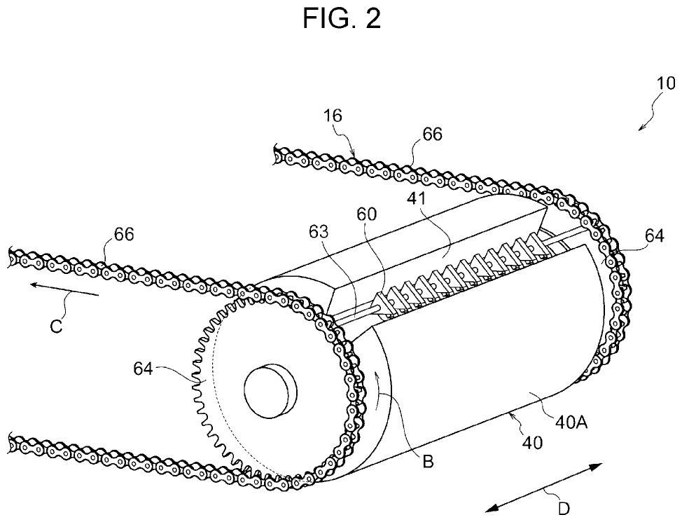

As illustrated in FIG. 1 and FIG. 2, the transfer cylinder 40 includes a recessed portion 41 that is formed on an outer circumferential surface 40A and rotates in a rotation direction B. The recessed portion 41 is elongated in the axial direction of the transfer cylinder 40 and has a depth in a radial direction of the transfer cylinder 40.

As illustrated in FIG. 1, the transfer cylinder 40 is disposed below the transfer belt 30 and faces the transfer belt 30. As for the transfer cylinder 40, a portion of the outer circumferential surface 40A in a range from an upstream end to a downstream end of the recessed portion 41 in the rotation direction comes into contact with the transfer belt 30.

As illustrated in FIG. 2, two sprockets 64 are disposed at both ends of the transfer cylinder 40 in the axial direction. The two sprockets 64 are disposed coaxially with the transfer cylinder 40. A cylinder body is rotated in the rotation direction B by using a drive unit (not illustrated), and the transfer cylinder 40 consequently rotates in the rotation direction B together with the two sprockets 64.

According to the present exemplary embodiment, the transfer belt 30 and the transfer cylinder 40 transport the recording medium P with the recording medium P interposed therebetween at a second transfer position T2 (see FIG. 1). A second transfer electric field is applied between the facing roller 34 and the transfer cylinder 40, and the toner images that are transferred to the transfer belt 30 are consequently transferred to the recording medium P at the second transfer position T2. Grippers 60 and mount members 63 described later hold the recording medium P and are contained in the recessed portion 41 when passing through the second transfer position T2 so as not to come into contact with the transfer belt 30.

### Fixing Device 15

According to the present exemplary embodiment, the fixing device 15 fixes the toner images that are transferred to the recording medium P by using the transfer cylinder 40 to the recording medium P. Specifically, as illustrated in FIG. 1, the fixing device 15 includes a fixing cylinder 50, a heat roller 52, and a cleaning mechanism 70. The heat roller 52 is an example of a fixing unit.

As for the fixing device 15, the heat roller 52 is disposed above the fixing cylinder 50. The heat roller 52 is in contact with a pair of external heat rollers 54 and is heated by the pair of external heat rollers 54.

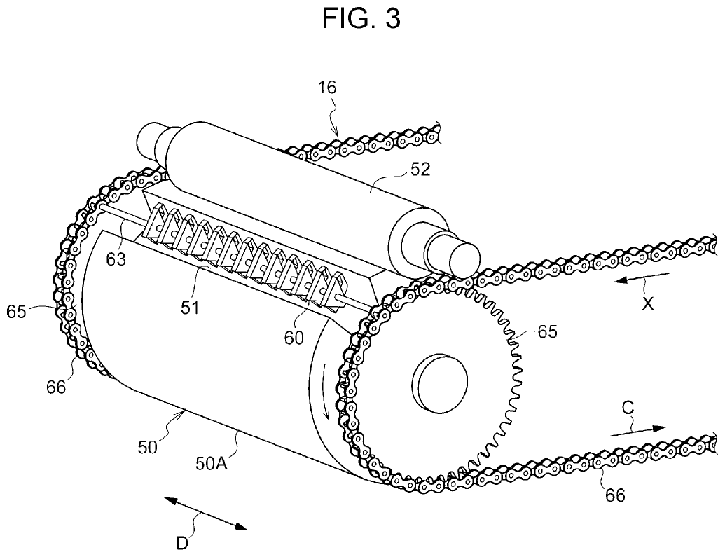

As illustrated in FIG. 1 and FIG. 3, the fixing cylinder 50 includes a recessed portion 51 that is formed on an outer circumferential surface 50A and rotates in a rotation direction E. The rotation direction E is an example of a predetermined rotation direction. The recessed portion 51 is formed on a portion of the outer circumferential surface of the fixing cylinder 50 in a circumferential direction. The recessed portion 51 is elongated in the axial direction of the fixing cylinder 50 and has a depth in the radial direction of the fixing cylinder 50. The grippers 60 and the mount members 63 described later are contained in the recessed portion 51. Consequently, the grippers 60 and the mount members 63 do not come into contact with the heat roller 52 when passing through a fixing position NP illustrated in FIG. 1.

Two sprockets 65 are disposed at both ends of the fixing cylinder 50 in the axial direction. The two sprockets 65 are disposed coaxially with the fixing cylinder 50. The fixing cylinder 50 is rotated in the rotation direction E by using a drive unit (not illustrated) in the rotation direction E and consequently rotates together with the two sprockets 65.

As for the fixing device 15, the heat roller 52 and the fixing cylinder 50 transport the recording medium P with the recording medium P interposed therebetween at the fixing position NP, heat and press the recording medium P, and consequently fix the toner images that are transferred to the recording medium P to the recording medium P. The cleaning mechanism 70 will be described later.

### Transport Mechanism 16

The transport mechanism 16 illustrated in FIG. 1 transports the recording medium P. As illustrated in FIG. 1 and FIG. 2, the transport mechanism 16 includes two chains 66 and the grippers 60 that are examples of a holding member. In FIG. 1, one of the two chains 66 is illustrated, and an illustration of the chain 66 and the grippers 60 is simplified.

As illustrated in FIG. 1, the two chains 66 are annular. As illustrated in FIG. 2, the two chains 66 are arranged at an interval in the depth direction (the direction of the arrow D in the figure) of the apparatus. The two chains 66 are wound around the respective sprockets 64 that are disposed at both ends of the transfer cylinder 40 in the axial direction and the respective sprockets 65 (see FIG. 3) that are disposed at both ends of the fixing cylinder 50 in the axial direction. The transfer cylinder 40 and the two sprockets 64 are rotated in the rotation direction B (the direction of an arrow B) together, and the chains 66 consequently turn in a circumferential direction C (the direction of an arrow C).

As illustrated in FIG. 2, the mount members 63 on which the grippers 60 are mounted extend between the two chains 66 in the depth direction of the apparatus. The multiple mount members 63 are fixed to the two chains 66 at a predetermined interval in the circumferential direction C in which the chains 66 turn.

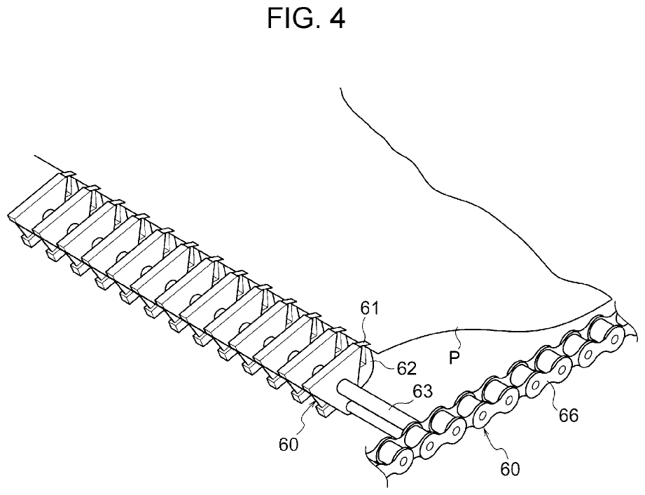

As illustrated in FIG. 2, the multiple grippers 60 are mounted on the mount members 63 at a predetermined interval in the depth direction of the apparatus. The grippers 60 function as the holding member that holds a leading edge portion of the recording medium P. Specifically, as illustrated in FIG. 4, each gripper 60 includes a pawl 61 and a pawl base 62. The gripper 60 holds the recording medium P by interposing the leading edge portion of the recording medium P between the pawl 61 and the pawl base 62. As for the gripper 60, for example, the pawl 61 is pressed against the pawl base 62 by using, for example, a spring, and the pawl 61 opens or closes with respect to the pawl base 62 by using, for example, a cam action.

As for the transport mechanism 16, as illustrated in FIG. 4, the grippers 60 hold the leading edge portion of the recording medium P that is fed from a container unit (not illustrated) that contains the recording medium P. The chains 66 turn in the circumferential direction C, and the grippers 60 that hold the leading edge portion of the recording medium P consequently transport the recording medium P and pass through the second transfer position T2 and the fixing position NP. The toner images that are stacked on and first-transferred to the transfer belt 30 at the first transfer positions T1 for the respective colors are second-transferred to the recording medium P at the second transfer position T2.

The chains 66 turn in the circumferential direction C, the grippers 60 that hold the leading edge portion of the recording medium P consequently transport the recording medium P and pass through the fixing position NP. At the fixing position NP, the recording medium P that is held by the grippers 60 is located on the outer circumferential surface 50A of the fixing cylinder 50 in a contact range 56 described later.

The recording medium P that is located on the outer circumferential surface 50A of the fixing cylinder 50 in the contact range 56 described later is interposed between the heat roller 52 and the fixing cylinder 50, and the images on the recording medium P are fixed to the recording medium.

The grippers 60 are contained in the recessed portion 41 that is formed on the outer circumferential surface of the transfer cylinder 40 together with the mount members 63 when passing through the second transfer position T2 and are contained in the recessed portion 51 that is formed on the outer circumferential surface of the fixing cylinder 50 together with the mount members 63 when passing through the fixing position NP.

### Cleaning Mechanism 70

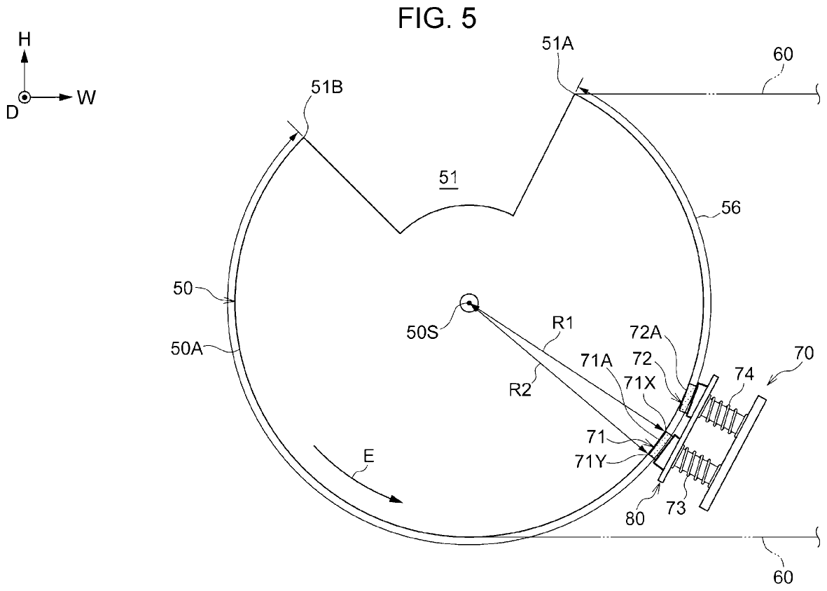

The cleaning mechanism 70 cleans the outer circumferential surface 50A of the fixing cylinder 50. As illustrated in FIG. 5, the cleaning mechanism 70 is disposed outside the fixing cylinder 50 in the radial direction and inside the chains 66 when viewed in the depth direction of the apparatus. In FIG. 5, parts of the chains 66 are simplified by using a two-dot chain line.

Specifically, the cleaning mechanism 70 includes cleaning members 71 and 72, a mount unit 80, and compression springs 73 and 74. The cleaning members 71 and 72 are examples of a removing unit. The compression springs 73 and 74 are examples of an application unit.

The cleaning members 71 and 72 are elongated in the depth direction (that is, the direction of the rotation axis of the fixing cylinder 50) of the apparatus and have a plate shape. Specifically, the cleaning members 71 and 72 have a plate shape such that the thickness direction thereof coincides with the radial direction of the fixing cylinder 50. As for the cleaning members 71 and 72, facing surfaces (referred to below as contact surfaces 71A and 72A) that face the outer circumferential surface 50A of the fixing cylinder 50 come into contact with the outer circumferential surface 50A of the fixing cylinder 50.

According to the present exemplary embodiment, the cleaning members 71 and 72 are composed of, for example, felt containing fibers. The cleaning members 71 and 72 do not rotate.

As for the cleaning mechanism 70, the contact surfaces 71A and 72A of the cleaning members 71 and 72 come into contact with a portion of the outer circumferential surface 50A in a range (referred to below as the contact range 56) from an upstream end 51A to a downstream end 51B of the recessed portion 51 due to rotation of the fixing cylinder 50 and remove foreign substances (such as toner and powder of the recording medium P) that adhere to the outer circumferential surface 50A. It is not necessary for the cleaning members 71 and 72 to come into contact with the portion over the entire contact range 56, provided that the cleaning members 71 and 72 come into contact with the portion at least in a part of the contact range 56.

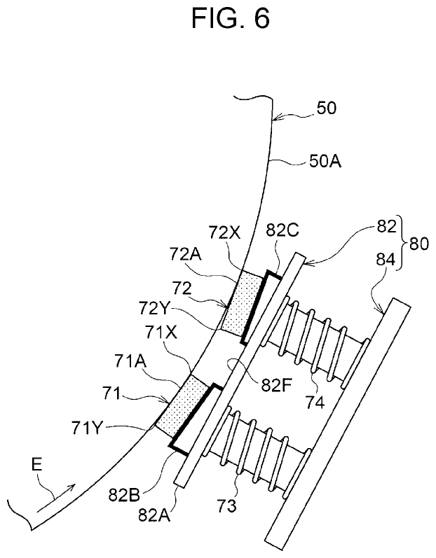

The mount unit 80 is a component on which the cleaning members 71 and 72 are mounted. Specifically, as illustrated in FIG. 6, the mount unit 80 includes a mount body 82 and a support 84.

The mount body 82 is a structure on which the cleaning members 71 and 72 are mounted. Specifically, the mount body 82 includes a body 82A and mount members 82B and 82C.

For example, the body 82A has a plate shape the thickness direction of which coincides with the radial direction of the fixing cylinder 50. The body 82A faces the outer circumferential surface 50A of the fixing cylinder 50. The body 82A faces the fixing cylinder 50 and has a facing surface 82F parallel with the tangential direction of the fixing cylinder 50.

The mount members 82B and 82C are arranged in the rotation direction E on the facing surface 82F of the body 82A. The cleaning members 71 and 72 are mounted on the mount members 82B and 82C with the cleaning members 71 and 72 inclined such that a first distance R1 (see FIG. 5) is shorter than a second distance R2 (see FIG. 5).

The first distance R1 is a distance in the radial direction from a downstream end 71X or 72X of the contact surface 71A or 72A in the rotation direction E to a rotation center 505 of the fixing cylinder 50. The second distance R2 is a direction in the radial direction from an upstream end 71Y or 72Y of the contact surface 71A or 72A in the rotation direction E to the rotation center 505.

The support 84 is disposed opposite the fixing cylinder 50 with respect to the mount body 82. The support 84 supports the mount body 82 such that the mount body 82 is movable between a first position (referred to below as an inner position) and a second position (referred to below as an outer position) in the radial direction of the fixing cylinder 50.

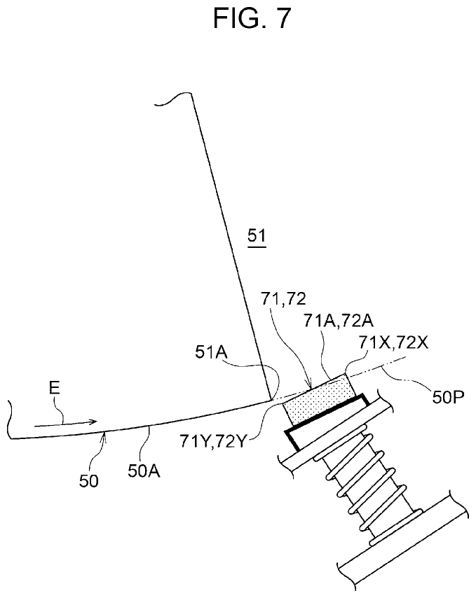

As for the cleaning members 71 and 72, as illustrated in FIG. 7, the downstream ends 71X and 72X of the contact surfaces 71A and 72A are located inside a motion trajectory 50P of the outer circumferential surface 50A of the fixing cylinder 50 in the radial direction, and the upstream ends 71Y and 72Y of the contact surfaces 71A and 72A are located outside the motion trajectory 50P in the radial direction in the case of the inner position. The contact surfaces 71A and 72A are examples of an inclined surface and are inclined with respect to the motion trajectory 50P in the case of the inner position.

The outer position is away from the inner position outward in the radial direction, and examples thereof are positions toward which the contact surfaces 71A and 72A of the cleaning members 71 and 72 are separated outward from the motion trajectory 50P of the outer circumferential surface 50A of the fixing cylinder 50 in the radial direction.

The compression springs 73 and 74 illustrated in FIG. 6 apply an inward load to the cleaning members 71 and 72 inward in the radial direction of the fixing cylinder 50. Specifically, first end portions of the compression springs 73 and 74 in the axial direction are in contact with the support 84, second end portions thereof in the axial direction are in contact with the mount body 82, and the mount body 82 is consequently pressed toward the inner position due to the inward load.

Consequently, when the fixing cylinder 50 is in a position of rotation such that the contact range 56 faces the cleaning members 71 and 72, the cleaning members 71 and 72 are pressed in the contact range 56 due to the inward load of the compression springs 73 and 74. The cleaning members 71 and 72 are mounted on the mount members 82B and 82C with the cleaning members 71 and 72 inclined as described above, and accordingly, the contact load of the contact surfaces 71A and 72A in the contact range 56 at downstream portions in the rotation direction E is larger than that at upstream portions in the rotation direction E.

According to the present exemplary embodiment, when the fixing cylinder 50 is in a position of rotation such that the recessed portion 51 faces the cleaning members 71 and 72, the cleaning members 71 and 72 enter the recessed portion 51 inward due to the inward load of the compression springs 73 and 74 (see FIG. 7).

As for the cleaning members 71 and 72 that enter the recessed portion 51, the downstream ends 71X and 72X of the contact surfaces 71A and 72A are located inside the motion trajectory 50P of the outer circumferential surface 50A of the fixing cylinder 50 in the radial direction, and the upstream ends 71Y and 72Y of the contact surfaces 71A and 72A are located outside the motion trajectory 50P in the radial direction in the case of the inner position.

For this reason, the contact surfaces 71A and 72A come into contact with the upstream end 51A of the recessed portion 51 to move the cleaning members 71 and 72 that enter the recessed portion 51 outward in the radial direction of the fixing cylinder 50 along with rotation of the fixing cylinder 50. A specific example of the upstream end 51A with which the contact surfaces 71A and 72A come into contact is a corner portion that is formed near an opening of the recessed portion 51.

According to the present exemplary embodiment, the contact surfaces 71A and 72A of the cleaning members 71 and 72 thus function as inclined surfaces that cause the cleaning members 71 and 72 to move outward in the radial direction of the fixing cylinder 50.

### Actions According to Present Exemplary Embodiment

According to the present exemplary embodiment, the contact surfaces 71A and 72A come into contact with the upstream end 51A of the recessed portion 51 to move the cleaning members 71 and 72 that enter the recessed portion 51 outward in the radial direction of the fixing cylinder 50 along with rotation of the fixing cylinder 50 as described above.

In this way, cleaning the outer circumferential surface 50A of the fixing cylinder 50 may be inhibited from failing (that is, removing the foreign substances may be inhibited from failing). Consequently, a stain on the recording medium P may be reduced, fixing the images to the recording medium P may be inhibited from failing, and an image failure may be inhibited from occurring.

According to the present exemplary embodiment, the inclined surfaces (specifically, the contact surfaces 71A and 72A) that cause the cleaning members 71 and 72 to move outward in the radial direction of the fixing cylinder 50 are located at the cleaning members 71 and 72.

In this way, the shape of the fixing cylinder 50 may be inhibited from being complex, unlike the case where the inclined surfaces are located at the upstream end 51A of the recessed portion 51 in the rotation direction.

According to the present exemplary embodiment, the contact surfaces 71A and 72A of the cleaning members 71 and 72 serve as the inclined surfaces that cause the cleaning members 71 and 72 to move outward in the radial direction of the fixing cylinder 50. In this way, the shapes of the cleaning members 71 and 72 may be inhibited from being complex, unlike the case where the cleaning members 71 and 72 have inclined surfaces that differ from the contact surfaces 71A and 72A.

According to the present exemplary embodiment, the contact load of the contact surfaces 71A and 72A of the cleaning members 71 and 72 in the contact range 56 at the downstream portions in the rotation direction E is larger than that at the upstream portions in the rotation direction E.

In the case where the contact load of the contact surfaces 71A and 72A in the contact range 56 is constant from the downstream portions to the upstream portions in the rotation direction E (referred to bellow as an aspect A), the foreign substances are removed only by upstream portions of the contact surfaces 71A and 72A. However, the contact load of the contact surfaces 71A and 72A in the contact range 56 at the downstream portions in the rotation direction E is larger than that at the upstream portions. In this way, the amount of the foreign substances that are removed by the contact surfaces 71A and 72A may be inhibited from varying in the rotation direction E, unlike the aspect A.

According to the present exemplary embodiment, the cleaning members 71 and 72 are mounted on the mount unit 80 with the cleaning members 71 and 72 inclined such that the first distance R1 (see FIG. 5) is shorter than the second distance R2 (see FIG. 5).

For this reason, the contact load of the contact surfaces 71A and 72A in the contact range 56 at the downstream portions in the rotation direction E is larger than that at the upstream portions in the rotation direction E regardless of the inward load that is applied from the compression springs 73 and 74 to the mount unit 80, unlike the case where the cleaning members 71 and 72 are mounted on the mount unit 80 such that the first distance R1 (see FIG. 5) is equal to the second distance R2 (see FIG. 5).

### Modification to Inclined Surface

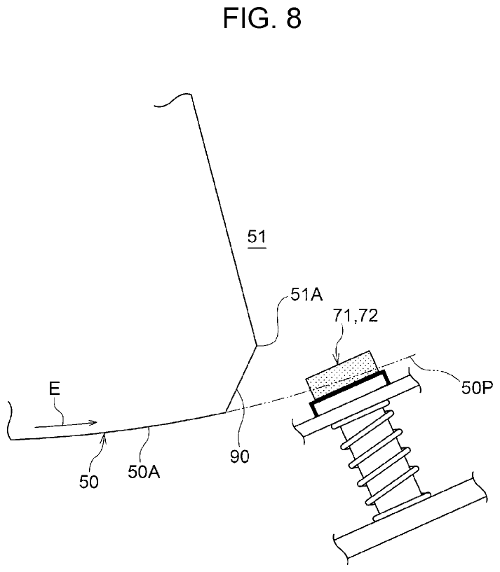

According to the present exemplary embodiment, the inclined surfaces (specifically, the contact surfaces 71A and 72A) that cause the cleaning members 71 and 72 to move outward in the radial direction of the fixing cylinder 50 are located at the cleaning members 71 and 72, but this is not a limitation. As illustrated in FIG. 8, an inclined surface 90 that causes the cleaning members 71 and 72 to move outward in the radial direction of the fixing cylinder 50 may be formed at the upstream end 51A of the recessed portion 51.

According to the present modification, the inclined surface 90 comes into contact with portions (such as corners of the upstream portions) of the cleaning members 71 and 72 to move the cleaning members 71 and 72 that enter the recessed portion 51 outward in the radial direction of the fixing cylinder 50 along with rotation of the fixing cylinder 50.

According to the present modification, management of the posture of the cleaning members 71 and 72 may be inhibited from being complex, unlike the case where the contact surfaces 71A and 72A of the cleaning members 71 and 72 serve as the inclined surfaces that cause the cleaning members 71 and 72 to move outward in the radial direction of the fixing cylinder 50.

According to the present modification, the contact load of the contact surfaces 71A and 72A in the contact range 56 may be constant from the downstream portions in the rotation direction E to the upstream portions.

### Modification to Compression Spring 73

According to the present exemplary embodiment, the cleaning member 71 is mounted on the mount member 82B with the cleaning member 71 inclined such that the first distance R1 (see FIG. 5) is shorter than the second distance R2 (see FIG. 5) as described above. Consequently, the contact load of the contact surface 71A in the contact range 56 at the downstream portion in the rotation direction E is larger than that at the upstream portion in the rotation direction E, but this is not a limitation.

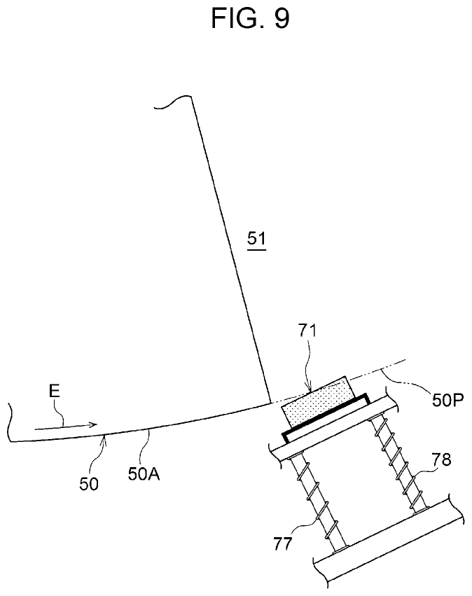

As for an example of the application unit, as illustrated in FIG. 9, compression springs 77 and 78 may be provided, and the inward load that is applied to the cleaning member 71 at the downstream portion of the contact surface 71A in the rotation direction E may be larger than that at an upstream portion thereof in the rotation direction E.

According to the present modification, the contact load of the contact surface 71A in the contact range 56 at the downstream portion in the rotation direction E is larger than that at the upstream portion in the rotation direction E regardless of the structure (for example, shape and posture) of the cleaning member 71, unlike the case where the inward load of the compression springs 77 and 78 is constant. The cleaning member 72 may have the same structure.

### Modifications to Rotator, Removing Unit, and Application Unit

According to the present exemplary embodiment, the fixing cylinder 50 is used as an example of the rotator, but this is not a limitation. Examples of the rotator may include the transfer cylinder 40, a transfer roller, and a transport roller.

According to the present exemplary embodiment, the cleaning members 71 and 72 are used as examples of the removing unit, but this is not a limitation. Examples of the removing unit may include a cleaning strip (a so-called web), a cleaning roller, a cleaning brush, and a blade for scraping the foreign substances. In the case of the cleaning strip, for example, a support unit (a so-called pad) that supports the cleaning strip opposite the fixing cylinder 50 with respect to the cleaning strip may have an inclined surface.

According to the present exemplary embodiment, the compression springs 73 and 74 are used as examples of the application unit, but this is not a limitation. Examples of the application unit may include other elastic members such as a tension spring and a plate spring.

### Other Modifications

According to the present exemplary embodiment, the contact surfaces 71A and 72A of the cleaning members 71 and 72 serve as the inclined surfaces that cause the cleaning members 71 and 72 to move outward in the radial direction of the fixing cylinder 50, but this is not a limitation. For example, the cleaning members 71 and 72 may have inclined surfaces that differ from the contact surfaces 71A and 72A. With this structure, it is thought that guide units (that is, guides) that have the inclined surfaces, for example, may be included in the cleaning members 71 and 72.

The present disclosure is not limited to the exemplary embodiment described above, and various modifications, alterations, and improvements may be made without departing from the spirit thereof. For example, the multiple modifications described above may be appropriately combined.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A rotation device includes a rotator that includes a recessed portion formed on an outer circumferential surface and that rotates in a predetermined rotation direction, a removing unit that comes into contact with a portion of the outer circumferential surface in a range from an upstream end to a downstream end of the recessed portion in the rotation direction due to rotation of the rotator and that removes a foreign substance that adheres to the outer circumferential surface, an application unit that applies an inward load to the removing unit inward in a radial direction of the rotator, and an inclined surface that is located at the removing unit or the upstream end and that comes into contact with the other of the removing unit or the upstream end to move the removing unit entering the recessed portion due to the inward load outward in the radial direction of the rotator along with rotation of the rotator.

(((2)))

As for the rotation device described in (((1))), the inclined surface is located at the removing unit.

(((3)))

As for the rotation device described in (((2))), the removing unit does not rotate, and the inclined surface is a contact surface of the removing unit that comes into contact with the portion in the range.

(((4)))

As for the rotation device described in (((3))), a contact load of the contact surface in the range at a downstream portion in the rotation direction is larger than that at an upstream portion in the rotation direction.

(((5)))

The rotation device described in (((4))) further includes a mount unit to which the inward load is applied by the application unit, and the removing unit is mounted on the mount unit with the removing unit inclined such that a first distance in the radial direction from a downstream end of the contact surface in the rotation direction to a rotation center of the rotator is shorter than a second distance in the radial direction from an upstream end of the contact surface in the rotation direction to the rotation center.

(((6)))

As for the rotation device described in (((4))), and as for the application unit, the inward load at the downstream portion of the contact surface in the rotation direction is larger than that at the upstream portion thereof in the rotation direction.

(((7)))

As for the rotation device described in any one of (((1))) to (((6))), the recessed portion contains a holding member that holds a recording medium, and as for the rotator, the recording medium that is held by the holding member is located on the outer circumferential surface in the range.

(((8)))

A fixing device serves as the rotation device described in (((7))) and includes a fixing unit that fixes an image on the recording medium to the recording medium with the recording medium that is located on the outer circumferential surface in the range being interposed between the fixing unit and the rotator.

(((9)))

An image forming apparatus includes an image forming unit that forms an image on the recording medium, and the fixing device described in (((8))) that fixes the image that is formed by the image forming unit to the recording medium.

What is claimed is:

1. A rotation device comprising:
a rotator that includes a recessed portion formed on an outer circumferential surface and that rotates in a predetermined rotation direction;
a removing unit that comes into contact with a portion of the outer circumferential surface in a range from an upstream end to a downstream end of the recessed portion in the rotation direction due to rotation of the rotator and that removes a foreign substance that adheres to the outer circumferential surface;
an application unit that applies an inward load to the removing unit inward in a radial direction of the rotator; and
an inclined surface that is located at the removing unit or the upstream end and that comes into contact with the other of the removing unit or the upstream end to move the removing unit entering the recessed portion due to the inward load outward in the radial direction of the rotator along with rotation of the rotator.

2. The rotation device according to claim 1,
wherein the inclined surface is located at the removing unit.

3. The rotation device according to claim 2,
wherein the removing unit does not rotate, and
wherein the inclined surface is a contact surface of the removing unit that comes into contact with the portion in the range.

4. The rotation device according to claim 3,
wherein a contact load of the contact surface in the range at a downstream portion in the rotation direction is larger than that at an upstream portion in the rotation direction.

5. The rotation device according to claim 4, further comprising:
a mount unit to which the inward load is applied by the application unit, and
wherein the removing unit is mounted on the mount unit with the removing unit inclined such that a first distance in the radial direction from a downstream end of the contact surface in the rotation direction to a rotation center of the rotator is shorter than a second distance in the radial direction from an upstream end of the contact surface in the rotation direction to the rotation center.

6. The rotation device according to claim 4,
wherein as for the application unit, the inward load at the downstream portion of the contact surface in the rotation direction is larger than that at the upstream portion thereof in the rotation direction.

7. The rotation device according to claim 1,
wherein the recessed portion contains a holding member that holds a recording medium, and
wherein as for the rotator, the recording medium that is held by the holding member is located on the outer circumferential surface in the range.

8. A fixing device that serves as the rotation device according to claim 7, the fixing device comprising:
a fixing unit that fixes an image on the recording medium to the recording medium with the recording medium that is located on the outer circumferential surface in the range being interposed between the fixing unit and the rotator.

9. An image forming apparatus comprising:
an image forming unit that forms an image on the recording medium; and
the fixing device according to claim 8 that fixes the image that is formed by the image forming unit to the recording medium.

10. A rotation device comprising:
a rotator that includes a recessed portion formed on an outer circumferential surface and that rotates in a predetermined rotation direction;
removing means for coming into contact with a portion of the outer circumferential surface in a range from an upstream end to a downstream end of the recessed portion in the rotation direction due to rotation of the rotator and for removing a foreign substance that adheres to the outer circumferential surface;
means for applying an inward load to the removing means inward in a radial direction of the rotator; and
an inclined surface that is located at the removing means or the upstream end and that comes into contact with the other of the removing means or the upstream end to move the removing means entering the recessed portion due to the inward load outward in the radial direction of the rotator along with rotation of the rotator.
